(19) United States
(12) Patent Application Publication
(10) Pub. No.: US 2020/0303873 A1
(43) Pub. Date: Sep. 24, 2020

(54) ELECTRICAL CONTACT PIN AND PLUG CONNECTOR

(71) Applicant: Tyco Electronics Raychem GmbH, Ottobrunn (DE)

(72) Inventors: Torsten Friedrich, Martinsried (DE); Axel Winter, Munchen (DE)

(73) Assignee: Tyco Electronics Raychem GmbH, Ottobrunn (DE)

(21) Appl. No.: 16/896,606

(22) Filed: Jun. 9, 2020

Related U.S. Application Data
(63) Continuation of application No. PCT/EP2018/085865, filed on Dec. 19, 2018.

(30) Foreign Application Priority Data
Dec. 20, 2017 (EP) 17209060.7

(51) Int. Cl. H01R 13/53; H01R 4/56; H01R 9/18; H01R 13/05

(52) U.S. Cl. CPC H01R 13/53; H01R 4/56; H01R 2101/00; H01R 13/052; H01R 9/18

(57) ABSTRACT

An electrical contact pin for a plug connector includes an outer thread fastening the electrical contact pin to the plug connector and a centering element having a tapered section centering and/or positioning the electrical contact pin. The centering element extends from an end of the electrical contact pin.

### CROSS-REFERENCE TO RELATED APPLICATIONS

This application is a continuation of PCT International Application No. PCT/EP2018/085865, filed on Dec. 19, 2018, which claims priority under 35 U.S.C. § 119 to European Patent Application No. 17209060.7, filed on Dec. 20, 2017.

### FIELD OF THE INVENTION

The present invention relates to an electrical contact pin and, more particularly, to an electrical contact pin having an outer thread for fastening the electrical contact pin to a plug connector.

### BACKGROUND

In electronics, in particular in medium voltage electronics, electrical contact pins and plug connectors comprising such electrical contact pins are known. In the literature, the term “medium voltage” is not uniformly defined. According to the NEMA (National Electrical Manufacturers Association) and the IEEE (Institution of Electrical and Electronic Engineers), medium voltage describes voltages in the order of 0.6 kV up to 100 kV. Electrical contact pins and plug connectors, however, may be applied for all obtainable voltages.

In general, electrical contact pins applied in the field of medium voltages comprise a thread for installation in a plug connector. The plug connectors usually have a monolithic insulating sheath or an insulating layer or a screen in order to protect a technician or a person adjacent to an energized cable/connector and to allow lower clearance to grounded parts.

During the installation of the electrical contact pin to the plug connector, the contact member, with which the electrical contact pin is electrically connected, may be improperly positioned within the insulating sheath. Installation of the electrical contact pin may thus be complicated, the electrical contact pin may get stuck during the installation process, and in the worst case, the electrical contact pin may be damaged as the highly conductive metallic material of the pin is rather soft.

### SUMMARY

An electrical contact pin for a plug connector includes an outer thread fastening the electrical contact pin to the plug connector and a centering element having a tapered section centering and/or positioning the electrical contact pin. The centering element extends from an end of the electrical contact pin.

### BRIEF DESCRIPTION OF THE DRAWINGS

The invention will now be described by way of example with reference to the accompanying Figures, of which:

FIG. 1 is a side view of an angled plug;

FIG. 2 is a top view of the angled plug of FIG. 1;

FIG. 3A is a side view of an electrical contact pin according to an embodiment;

FIG. 3B is a perspective view of the electrical contact pin of FIG. 3A;

FIG. 4 is a side view of an electrical contact pin according to another embodiment;

FIG. 5 is a perspective view of the electrical contact pin of FIG. 3A during assembly with a contact member; and

FIG. 6 is a sectional side view of a plug connector according to an embodiment.

### DETAILED DESCRIPTION OF THE EMBODIMENT(S)

In the following, specific embodiments of the inventive electrical contact pin as well as the inventive plug connector will be described based on the accompanying figures. The figures merely depict particular embodiments which are shown exemplarily but which do not limit the scope of protection defined by the claims. The technical features of the following embodiments may be arbitrarily combined and/or omitted if the technical effect obtained with the omitted technical feature is not relevant to the invention. The same technical features, as well as technical features having the same technical effect, will be referred to using the same reference numeral in each case. A repetitive description of technical features will be omitted, whereas differences between the embodiments will be emphasized.

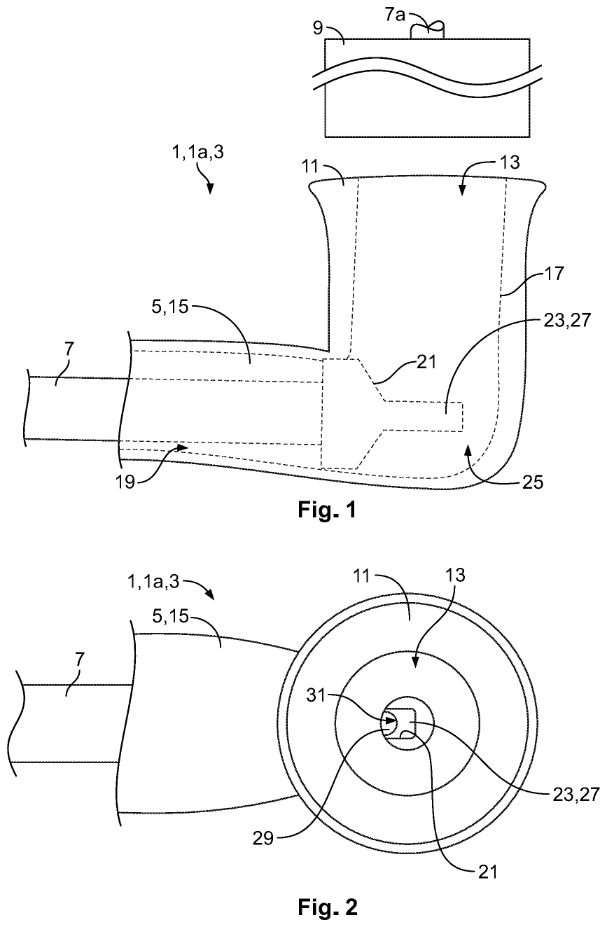

In FIG. 1 a plug connector 1, which is embodied as an angled plug 3 is shown in an assembled state 1a in a side view. Here, only an insulating sheath 5 is shown. Further elements located inside the insulating sheath 5 will be described with reference to FIG. 2.

The plug connector 1 may be used to establish an electrical connection between a cable 7 and a schematically shown mating plug connector 9 which is connected to a further cable 7a.

In other embodiments, the mating plug connector 9 may be a bushing on a switchgear or transformer. In the case of a so-called “elbow connector”, a further cable 7a may be used occasionally. The insulating sheath 5 protects a user from electrical hazards and injuries resulting from an electric shock.

The plug connector 1 may be considered according to relevant standards (e.g. IEC 60502-4). Two types of contacts of so-called “separable connectors” are differentiated: “plug-in” separable connectors or sliding contact connectors and “bolted” type (screwable) separable connectors. Concerning plug connectors, there are two types of separable connectors which are differentiated: screened and unscreened types. Both types use conductive inserts typically molded in insulating material, whereby screened connectors use an additional layer of conductive material on the outside. The conductive material is typically similar to the insulating material, but may be mixed with conductive filler. Furthermore, adapters as additional components may be used to adapt on size of connector body to different cable sizes. In the case of a screened connector, a screen may protect the user.

FIG. 2 shows a top view of the plug connector 1. A ring-shaped elastic collar 11 is provided to protect a pin receptacle 13 from dust and/or water, and to insulate it from elements outside the pin receptacle 13. The insulating sheath 5 is generally made from an elastic insulating material 15 and formed monolithically with the elastic collar 11.

The insulating sheath 5, as shown in FIG. 1, has a sheath receptacle 17 which is indicated by a dotted line. The sheath receptacle 17 is composed of the pin receptacle 13 and a contact receptacle 19. A contact member 21 is received in the sheath receptacle 17, wherein a connection region 23 is located in an angled portion 25 of the sheath receptacle 17 and is thus visible through the pin receptacle 13, as shown in FIG. 2.

The connection region 23 of the contact member 21 is embodied as a cable lug 27 having a through hole 29 with an inner thread 31, as shown in FIG. 2. The through hole 29 is not centered in the pin receptacle 13, thereby rendering the installation of an electrical contact pin (to be described in the following figures) difficult.

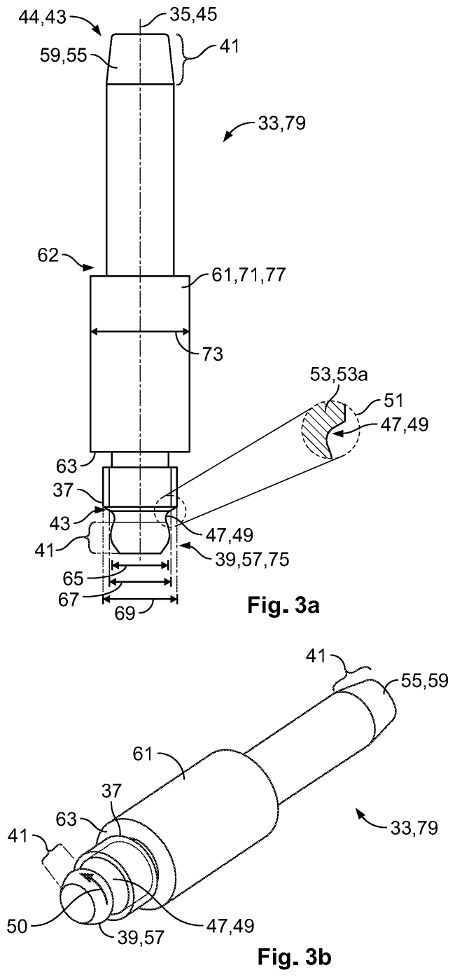

An electrical contact pin 33 according to a first embodiment is shown in FIGS. 3A and 3B. The electrical contact pin 33 extends along a longitudinal direction 35 indicated by a dash-dotted line. The electrical contact pin 33 comprises an outer thread 37, which may be used to fasten the electrical contact pin 33 to the plug connector 1, exemplarily to the plug connector 1 shown in FIGS. 1 and 2.

The electrical contact pin 33, as shown in FIGS. 3A and 3B, has a centering element 39. The centering element 39 has a tapered section 41 which extends from an end 43 of the electrical contact pin 33 along the longitudinal direction 35. The longitudinal direction 35 corresponds to the direction of extension 45 of the electrical contact pin 33. The tapered section 41 is to be understood as a section which becomes progressively smaller towards one end, i.e. towards the end of the tapered section 41 away from the electrical contact pin 33. A diameter of a cross-section of the tapered section 41 decreases as the distance from the electrical contact pin 33 increases.

A spacer 47 is disposed between the tapered section 41 and the outer thread 37. The spacer 47 is embodied as a circumferential notch portion 49, which is shown in more detail in a circle 51 in FIG. 3A, which shows a cross-section 53 of the circumferential notch portion 49 as seen in the circumferential direction 50. The circumferential notch portion 49 has a continuous cross-section 53a.

At an end 44 opposite to the centering element 39, a further centering element 55 is disposed, as shown in FIGS. 3A and 3B. The further centering element 55 also has a tapered section 41. Each of the two tapered sections 41 of the electrical contact pin 33 has a partially spherical shape 57 or a frustoconical shape 59 for the centering element 39 and the further centering element 55, respectively.

The tapered section 41 may have a cross-section, i.e. the section in a plane perpendicular to the extension direction of the electrical contact pin 33, that is essentially circular, wherein in this case, the tapered section 41 may have the shape of a cone with its flat base located at the end of the electrical contact pin 33. The cone, in an embodiment, is a right circular cone (not an oblique cone) and may be embodied as an entire cone or a cone with a cut apex resulting in a truncated cone. In a different embodiment, the tapered section 41 may have a polygonal shape with n edges. The tapered section 41 may exemplarily be embodied as a pyramid, i.e. with four edges. The pyramid may comprise an apex or may be cut and be embodied as a truncated pyramid. When the cross-section of the tapered section 41 has a polygonal shape, a circumscribed circle may be constructed that contains all edges of the polygon. The diameter of the circumscribed circle becomes progressively smaller towards the end of the tapered section 41, i.e. away from the electrical contact pin 33. In the case of a polygon-shaped cross-section of the tapered section 41, the maximum diameter of the centering element 39 corresponds to the circumscribed circle or the largest dimension of the centering element 39 in the plane of the cross-section.

In an embodiment, an axis of symmetry (for example rotational axis) of the tapered section 41 coincides with an axis of symmetry of the electrical contact pin 33. This allows for centering and/or positioning of the electrical contact pin 33 independently of an initial rotational orientation of the electrical contact pin 33.

As shown in FIGS. 3A and 3B, the electrical contact pin 33 further comprises an abutment member 61 having an abutment surface 63. The abutment surface 63 faces towards the centering element 39 and is oriented essentially perpendicular to the longitudinal direction 35. In a different embodiment of the inventive electrical contact pin 33, the outer thread 37 and/or the abutment member 61 may be located in a central portion 62 of the electrical contact pin 33.

The outer thread 37 may be provided along the entire electrical contact pin 33, or only at sections thereof, in particular at the ends of the contact pin 33 or adjacent to the abutment member 61. The electrical contact pin 33, in particular the abutment member 61, may be embodied symmetrically, such that the same geometry of the plug connector 1 is obtained independently of the direction in which the electrical contact pin 33 is inserted into the contact member 21.

In the embodiment of the inventive electrical contact pin 33 shown in FIGS. 3A and 3B, a maximum diameter 65 of the centering element 39 is smaller than a minor diameter 67 of the outer thread 37. Both diameters 65, 67 are smaller than an outer diameter 69 of the outer thread 37. The abutment member 61, which is also embodied as a stop member 71, has a diameter 73 which is larger than the outer diameter 69 of the outer thread 37. The centering element 39 and the abutment member 61 have a rotationally symmetrical shape 75 and the shape of a cylinder 77 in the embodiments shown in FIGS. 3A and 3B. Both elements 39, 61 may have a cross-section in the form of a polygon; in this case, the term “diameter” refers to a circumscribed circle of said cross-section.

The abutment member 61 may be embodied as a cylinder but may also have a polygon-shaped cross-section. In this case, the diameter of the circumscribed circle of the abutment member 61 cross-section is larger than the outer diameter of the outer thread 37.

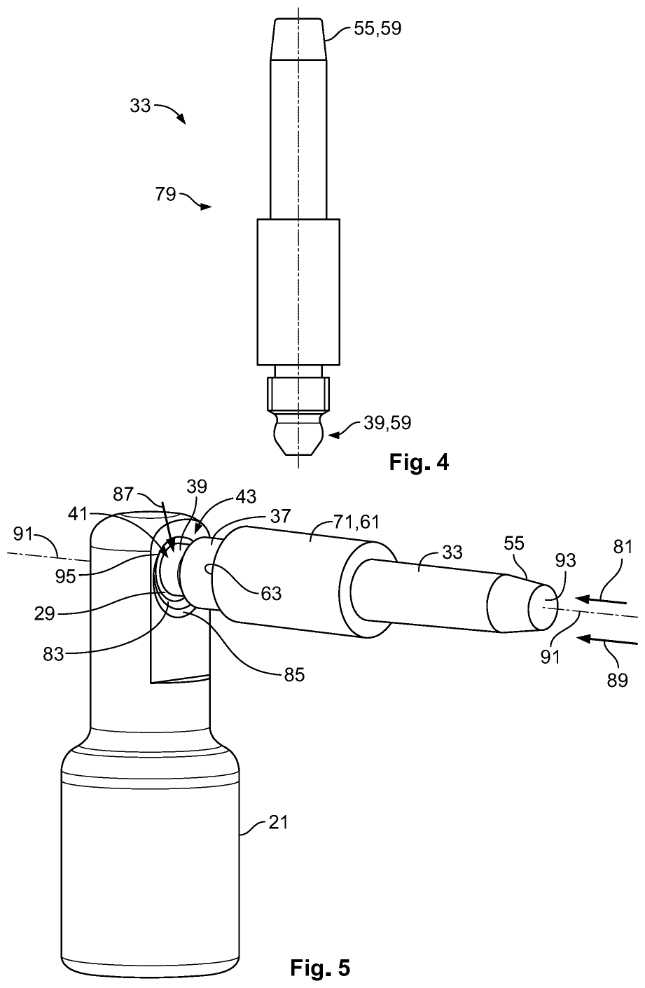

An electrical contact pin 33 according to a second embodiment, as shown in FIG. 4, differs from the first embodiment of FIGS. 3A and 3B in the shape of the centering element 39, which has a frustoconical shape 59, i.e. the centering element 39 as well as the further centering element 55 have a frustoconical shape 59. The electrical contact pins 33 shown in the embodiments of FIGS. 3A, 3B, and 4 are in each case embodied as a monolithic part 79. It is, however, possible for the centering element 39 and/or the further centering element 55 to be manufactured individually and separately, and attached to the electrical contact pin 33 prior to installation of the electrical contact pin 33 in the plug connector 1.

FIG. 5 shows the electrical contact pin 33 of FIGS. 3A and 3B during assembly to the contact member 21 of a plug connector 1. For the sake of visibility, the insulating sheath 5, the sheath receptacle 17, the pin receptacle 13 and the contact receptacle 19 are not shown in FIG. 5 (see FIG. 1).

The electrical contact pin 33 is moved along an insertion direction 81 such that the centering element 39 approaches the through hole 29, which is provided with an inner thread 83. FIG. 5 shows an embodiment of the contact member 21, which also comprises a chamfered entrance edge 85, i.e. a circumferentially beveled or chamfered edge surrounding the through hole 29. If the electrical contact pin 33, in particular its tapered section 41, abuts the chamfered entrance edge 85 of the contact member, a centering and positioning force 87 is exerted on the end 43 of the electrical contact pin 33. It is to be noted that the direction of the centering and positioning force 87 shown in FIG. 5 is exemplary and may vary depending on where the tapered section 41 abuts the chamfered entrance edge 85 of the through hole 29.

The spacer 47 increases the distance between the centering element 39 and the outer thread 37 and allows for a larger angle of acceptance. The angle of acceptance is to be understood as an angle of the electrical contact pin 33 with respect to a normal direction of the inner thread 83 of the contact element into which the electrical contact pin 33 is inserted. In other words, with the spacer 47, the electrical contact pin 33 may be reliably centered and/or positioned by the centering element 39, even if an angular misalignment of the electrical contact pin 33 is present. The notch portion 49 prevents the outer thread 37 from being blocked at the inner thread 83 of the contact member 21, wherein the continuous cross-section of the notch 49 avoids notch stress maxima which could result in cracks and further damage to the electrical contact pin 33.

In all cases, an insertion force 89, which is exerted on the electrical contact pin 33 in the insertion direction 81, is split and one resulting component of the insertion force 89 is the centering and positioning force 87, which is directed towards a central axis 91 of the through hole 29. As can be seen at the further centering element 55, the central axis 91 may be positioned at a distance from a center point 93 of the electrical contact pin 33. The center point 93 is to be understood as the point through which the longitudinal direction 35, shown in FIG. 3A, extends through the further centering element 55. For the sake of visibility, the longitudinal direction 35 is not shown in FIG. 5.

Upon further insertion of the electrical contact pin 33 into the through hole 29, the outer thread 37 of the electrical contact pin 33 engages with the inner thread 83 of the through hole 29 and the electrical contact pin 33 may be screwed into the contact member 21. The electric contact pin 33 may be screwed into the through hole 29 until the abutment surface 63 of the abutment member 61 abuts an electrical contact surface 95, which is arranged circumferentially around the chamfered entrance edge 85 of the through hole 29.

The abutment member 61, more precisely the abutment surface 63 of the abutment member 61, may be applied to establish a mechanical contact between the electrical contact pin 33 and the contact member 21 over an even area or surface. Such a flat abutment between both the contact pin 33 and the contact member 21 establishes the electrical connection between the contact pin 33 and the contact member 21. Although the outer thread 37 of the electrical contact pin 33 is in mechanical and electrical contact with the inner thread 83 of the contact member, electrical current mainly flows through the abutment surface between the electrical contact pin 33 and the contact member 21. The abutment member 61 may further comprise a flange section or a flange-like structure in order to increase the contact surface between the abutment member 61 and the contact member 21. Further extensions of the abutment member 61 may be embodied to increase the contact surface.

In an embodiment, the inner thread 31 is recessed, such that the abutment surface 63 of the abutment member 61 abuts a surface surrounding the inner thread 31 in a central portion of the contact member 21. The central portion of the contact member 21 is determined with respect to the extension of the (received) electrical contact pin 33.

The abutment of the abutment member 61 automatically limits an insertion depth of the electrical contact pin 33 into the contact member 21. The abutment member 61 may also be embodied monolithically with the electrical contact pin 33. If the abutment is established, the abutment member 61 also acts as stop member 71.

In an embodiment, in the assembled state, the electrical contact pin 33 is flush with the contact member 21. The flush alignment may be realized by the abutment member 61, wherein an overall length from the end of the centering element 39 to the abutment surface 63 of the abutment member 61 may equal a thickness of the contact member 21 into which the electrical contact pin 33 is screwed. Once the abutment between the abutment member 61 and the contact member 21 is established, the flush position of the electrical contact pin 33 is achieved.

The centering element 39 may be applied solely during the process of inserting the electrical contact pin 33 into the corresponding contact member 21. Consequently, the mechanical and electrical requirements of the centering element 39 may differ from the requirements related to mechanical and/or electrical properties of the electrical contact pin 33. For example, the centering element 39 may comprise a material different from the material of the electrical contact pin 33. In order to avoid damage to the inner thread 83 of the contact member 21, the centering element 39 may comprise a polymer with a lower hardness then the material of the inner thread 83 of the contact member 21. A misaligned introduction of the electrical contact pin 33 into the contact member 21 may thus not damage the inner thread 83. A polymer of the centering element 39 may therefore be considered as sacrificial material which does not negatively affect the integrity of the inner and/or outer thread.

In another embodiment, the centering element 39 and/or the spacer 47 are embodied monolithically with the electrical contact pin 33. A monolithic embodiment has the advantage that it is easily produced and does not require further assembly steps.

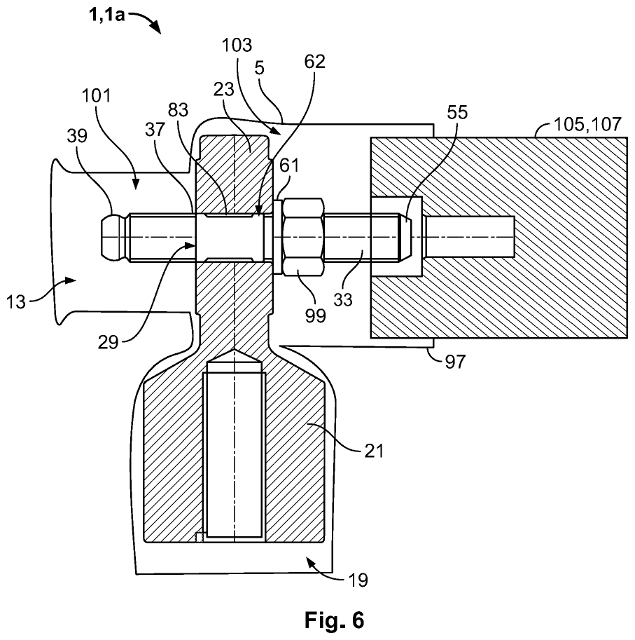

The plug connector 1 is shown in the assembled state 1a in FIG. 6. The insulating sheath 5 has a T-shape 97 and receives the contact member 21 in the contact receptacle 19, wherein the connection region 23 of the contact member 21 extends into the pin receptacle 13, which is oriented essentially perpendicular to the contact receptacle 19. A third embodiment of the electrical contact pin 33 is received and fixed in the connection region 23 by engaging the outer thread 37 with the inner thread 83 of the through hole 29.

This assembly may also be applied in an elbow connector. The plug connector 1, in the shown embodiment, has the contact member 21 oriented essentially perpendicular to the electrical contact pin 33. This embodiment results in the angled plug 3, wherein the contact member 21 is connected to and oriented parallel to a cable, which is essentially perpendicular to the electrical contact pin 33. Angled plugs 3 allow for an electrical connection when installation space is limited.

In another embodiment of the T-connector, a through hole may be provided instead of the inner thread 83, wherein the outer thread 37 may engage with and may be fixed to a separate element, e.g. a bushing located on the opposite end 44.

The abutment member 61 and the outer thread 37 are arranged in the central portion 62 of the electrical contact pin 33, as shown in FIG. 6. The abutment member 61 is embodied differently than in the previous figures and is provided with a screw nut 99 for attaching the electrical contact pin 33 to the contact member 21.

The centering element 39 was applied to center the electrical contact pin 33 in an initial stage of the assembly (see FIG. 5) and subsequently projects through the through hole 29 towards a first contact side 101 of the plug connector 1, as shown in FIG. 6. On a second contact side 103 of the plug connector 1, the electrical contact pin 33 extends from the connection region 23 of the contact member 21, wherein the further centering element 55 may be applied for centering and/or positioning an additional element 105 that is also to be attached to the electrical contact pin 33. The additional element 105 may be embodied as a further connector, an insulating member 107 or an extension embodied as a coupling piece. In an embodiment, the electrical contact pin 33 projects symmetrically through the contact member 21, i.e. it extends symmetrically to both sides of the contact member 21. The electrical contact pin 33 may be inserted into the contact member 21 so far that it projects through the contact member 21 in both directions along the extension of the electrical contact pin 33. The electrical contact pin 33 may therefore be centered in the plug connector 1.

One end of the electrical contact pin 33 may be applied as a central pin of the plug connector 1, wherein the second end of the electrical contact pin 33 may represent a second connection possibility, which, to protect a user against electrical hazards, may be provided with a basic insulating plug or an insulating back plug. Such a plug connector 1 is known as a T-plug, which may allow one single cable to be simultaneously connected to two other cables.

However, typically, a separable connector may be connected to a bushing e.g. on a switchgear or transformer. T-plugs may thus enable an additional connection of components, e.g. to another T-plug, which can then be connected to another plug, and/or a surge arrester. The entire T-plug may be located within a T-shape 97 of the insulating sheath 5, wherein the electrical contact pin 33 through and is electrically connected to the contact member 21 and provides two ends that allow an electrical connection with the contact member 21.

It is to be noted that, in contrast to commonly known plug-in connectors, the electrical contact pin 33 or screwable T-connector is itself not primarily intended to transmit current, but to establish a “fixed” mechanical connection between the cable lug 27 and e.g. a conductor of a bushing. The electrical contact is made via the surfaces of the cable lug 27 and the bushing.

It is to be noted that the plug connector 1 shown in FIG. 6 represents just one of a multitude of possible plug connectors 1, wherein in particular the shape of the insulating sheath 5, the shape and/or size of the pin receptacle 13 and/or contact receptacle 19 may be embodied differently in further possible embodiments.

The electrical contact pin 33 and the plug connector 1 allow for easy installation, reduced installation times and an increased durability against damage during assembly.

What is claimed is:

1. An electrical contact pin for a plug connector, comprising:
an outer thread fastening the electrical contact pin to the plug connector; and
a centering element having a tapered section centering and/or positioning the electrical contact pin, the centering element extends from an end of the electrical contact pin.

2. The electrical contact pin of claim 1, wherein the tapered section has a frustoconical shape or an at least partially spherical shape.

3. The electrical contact pin of claim 1, wherein a maximum diameter of the centering element is equal to or less than a minor diameter of the outer thread.

4. The electrical contact pin of claim 1, further comprising a spacer between the centering element and the outer thread.

5. The electrical contact pin of claim 4, wherein the spacer is a circumferential notch portion.

6. The electrical contact pin of claim 4, wherein the spacer has a continuous cross-section along a circumferential direction.

7. The electrical contact pin of claim 4, wherein the centering element and/or the spacer are monolithically formed in a single piece with the electrical contact pin.

8. The electrical contact pin of claim 1, further comprising an abutment member abutting a contact member of the plug connector.

9. The electrical contact pin of claim 8, wherein a diameter of the abutment member is larger than an outer diameter of the outer thread.

10. The electrical contact pin of claim 8, wherein the abutment member and/or the outer thread are located in a central portion of the electrical contact pin along an extension direction of the electrical contact pin.

11. The electrical contact pin of claim 1, wherein an end of the electrical contact pin opposite the centering element has a further centering element centering and/or positioning an additional element to the electrical contact pin.

12. A plug connector for establishing an electrical connection with a mating plug connector, comprising:
an insulating sheath;
a contact member at least partially received in a sheath receptacle of the insulating sheath; and
an electrical contact pin having an outer thread fastening the electrical contact pin to the plug connector and a centering element having a tapered section centering and/or positioning the electrical contact pin, the centering element extends from an end of the electrical contact pin.

13. The plug connector of claim 12, wherein the contact member is oriented essentially perpendicular to the electrical contact pin.

14. The plug connector of claim 13, wherein the electrical contact pin is flush with the contact member in an assembled state.

15. The plug connector of claim 13, wherein the electrical contact pin projects through the contact member in an assembled state.
